(19) United States
(12) Patent Application Publication
(10) Pub. No.: US 2006/0099027 A1
(43) Pub. Date: May 11, 2006

(54) Adjustable stem for a bicycle

(75) Inventor: Jim Liao, Hsin Chu Hsien (TW)

Correspondence Address: TROXELL LAW OFFICE PLLC, SUITE 1404, 5205 LEESBURG PIKE, FALLS CHURCH, VA, 22041, US

(73) Assignee: Hsin Lung Accessories Co., Ltd.

(21) Appl. No.: 10/984,785

(22) Filed: Nov. 10, 2004

(51) Int. Cl. F16D 1/00

(52) U.S. Cl. 403/322.4

(57) ABSTRACT

An adjustable stem for a bicycle comprises a vertical tube; a lateral tube having one end pivotally connected to the top end of the vertical tube and a lateral channel in the interior thereof; a push rod disposed within the lateral channel; an engaging block disposed at one end of the lateral tube; and a quick-release mechanism which allows the engaging block to movably push the top of the vertical tube and one end of the push rod so that the other end of the push rod tightly contacts the bicycle handle.

### BACKGROUND OF THE INVENTION

1. Field of the Invention

The present invention relates to a stem, in particular to a stem for a bicycle in which the angle of the stem and handle of the bicycle can be simultaneously adjusted.

2. Description of the Related Art

FIGS. 1 and 2 show a conventional stem for a bicycle which comprises a column member 1 inserted and fixed into the front fork and a lateral member 2 pivotally connected to the top of the column member 1 such a way that the teeth portion 3 at the top of the column 1 is engaged with the teeth portion 4 at the end portion 5 of the lateral member 2 and that a first bolt 6 passes through the hole 7 at the center of the teeth portion 4 of the lateral member 2 and is tightly screwed into the threaded bore 8 at the center of the teeth portion 3 of the column member 1. The angle between the column member 1 and the lateral member 2 can be adjusted by loosening the first bolt 6. However, once the angle is adjusted, the handlebar 9 should consequently be rotatably adjusted by loosening a second bolt 10 so that the gripping portions at the two ends of the handlebar 9 may be comfortably held by a user at an optimal angle and so that the brake lever (not shown) is adjusted to the desired position. Thus, such angle adjustments which involve operating the first and second bolts 6, 10, respectively, are quite troublesome.

### SUMMARY OF THE INVENTION

Accordingly, an object of the present invention is to provide an angle-adjustable stem for a bicycle which allows simultaneous adjustment of the angle of the stem and the position of the handle of the bicycle.

To achieve the object mentioned above, the present invention provides an adjustable stem for a bicycle which comprises a vertical tube; a lateral tube having one end pivotally connected to the top end of the vertical tube and a lateral channel in the interior thereof; a push rod disposed within the lateral channel; an engaging block disposed at one end of the lateral tube; and a quick-release mechanism which allows the engaging block to movably push the top of the vertical tube and one end of the push rod so that the other end of the push rod tightly contacts the bicycle handle.

### BRIEF DESCRIPTION OF THE DRAWINGS

FIG. 1 is an exploded perspective view of a conventional stem for a bicycle.

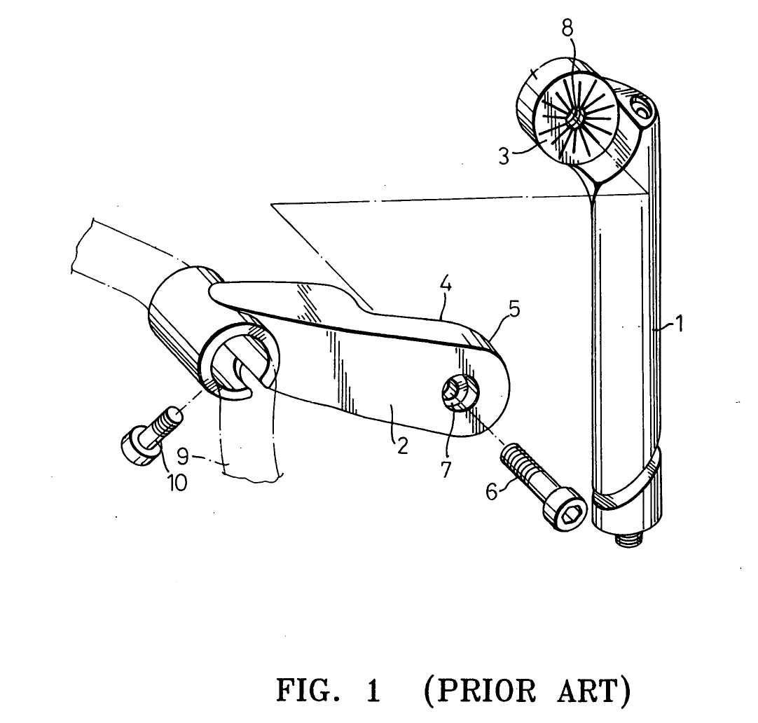

FIG. 2 is a perspective view of a conventional stem for a bicycle in assembled form.

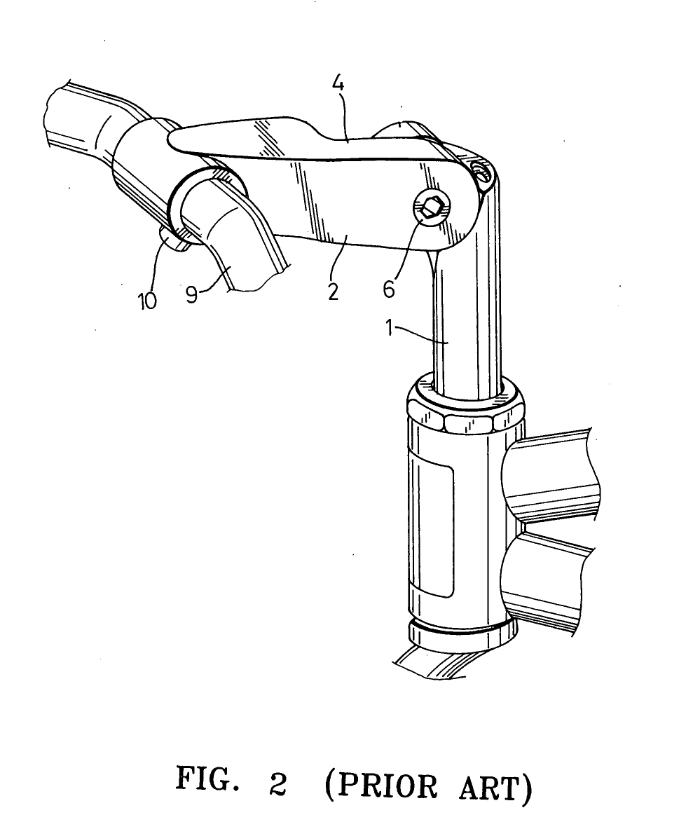

FIG. 3 is an exploded view of the bicycle stem according to the present invention;

FIG. 4 is a cross-sectional view of the bicycle stem of the present invention in the assembled form in an unlocked state;

FIG. 5 is a cross-sectional view of the bicycle stem of the present invention in the assembled form in a locked state.

### DETAILED DESCRIPTION OF THE PREFERRED EMBODIMENT

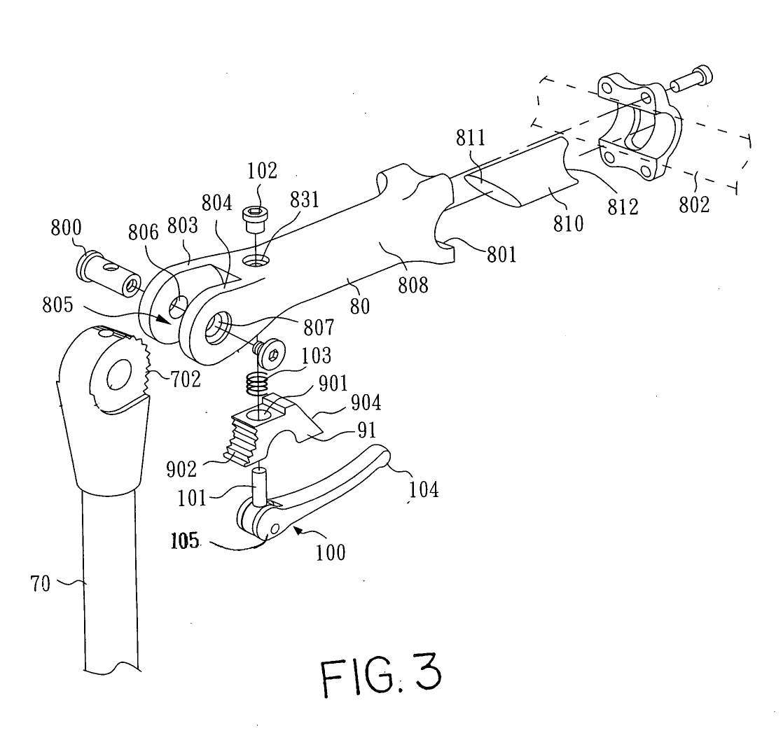

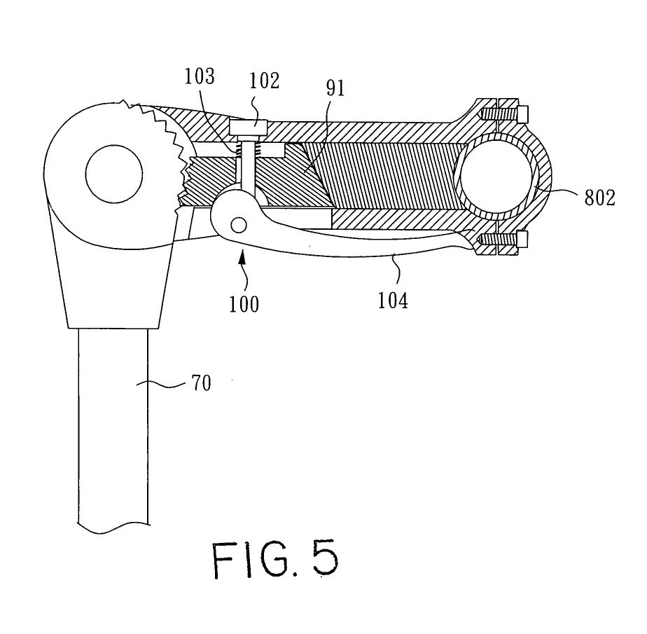

With reference to FIG. 3 and FIG. 5 which show a preferred embodiment of the present invention, the stem for a bicycle generally comprises a vertical tube 70, a lateral tube 80, an engaging block 91, a quick-release mechanism 100 and a push rod 810.

The lateral tube 80 has one end provided with a clamp 801 for securing the handle 802 of a bicycle, and another end provided with two connecting members 803,804 together defining a space 805. A lateral channel 808 is provided in the interior of the lateral tube 80. The lateral channel 808 has two ends, one end being in communication with the space 805 and the other end being in communication with the clamp 801. The connecting members 803,804, in conjunction with a pivot shaft 800 which passes through two bores 806,807 of the connecting members 803,804, and bore 701 of the vertical tube 70, are pivotally connected to the top end of the vertical tube 70 such that the lateral tube 80 is pivotable about the pivot shaft 800. In addition, a serrated section 702 is provided at the top end of the vertical tube 70.

The push rod 810 is disposed within the lateral channel 808 and has two ends, one end having a slanting face 811 and the other end having an arcuate face 812 which may make contact with the handle 802.

The engaging block 91 is provided with a serrated portion 902 on the side surface thereof, a slanting face 904 on the other surface thereof and has a longitudinal bore 901. The engaging block 91 can be fitted into the lateral channel 809 and the longitudinal bore 901 is aligned with a through bore 831 of the lateral tube 80. The serrated portion 702 engages the serrated portion 902 of the engaging block 91. The slanting face 904 contacts the slanting face 811 of the push rod 810.

The quick-release mechanism 100 includes a threaded rod 101, a compressed spring 103 and a lever 104 having an eccentric rotary member 105 for connecting to the top end of the threaded rod 101. The threaded rod 101 is passed through the longitudinal bore 901, the compressed spring 103 and the through bore 831 in that order, and then a nut 102 is screwed thereon, so that the engaging block 91 is positioned in the space 805 and will not fall off When the lever 104 is displaced to the horizontal state, the eccentric rotary member 105 rotates to urge the engaging block 91 to move upward and its respective serrated portion 902 contacts and engages the serrated section 702 of the vertical tube 70. At the same time, the slanting face 904 push the push rod 810 to move so that the arcuate face 812 tightly contacts the handle 802. Consequently, the lateral tube 80 and the handle 802 are fixed and immovable, respectively (as shown in FIG. 5).

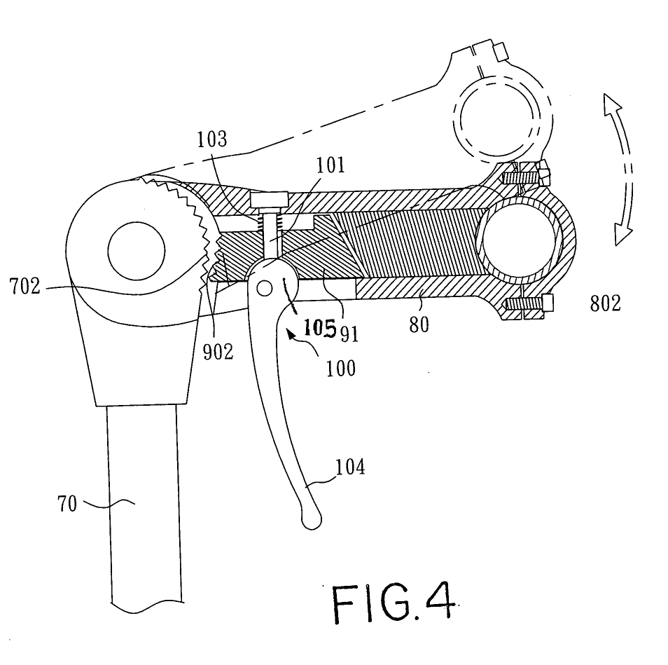

With reference to FIG. 4, the lever 104 as shown is actuated downwardly to a vertical state. This compels a change in the eccentric position of the rotary member 105 so that the engaging block 91 moves downwardly. The serrated portion 902 of the engaging block 91 is not in contact with the serrated section 702 of the vertical tube 70 as yet. At the same time, the slanting face 904 is not in contact with the slanting face 811,812 of the push rod 810. At this point, the lateral tube 80 may be pivoted downwardly or upwardly to the desired angle and the handle 802 may be also rotated to the desired angle. After the desired adjustment, the lever 103 is pushed downwardly. Accordingly, the objective of simultaneous adjustment of the angle of the lateral tube 80 and handle 802 is achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An adjustable stem for a bicycle comprising:
a vertical tube having a serrated section at the top end thereof;
a lateral tube having one end provided with a clamp for securing a handle, and another end provided with two connecting members defining a space for pivotal connection on a side of the top end of said vertical tube, and a lateral channel being provided in the interior of the lateral tube wherein the lateral channel has two ends, one end being in communication with said space and the other end being in communication with said clamp;
a push rod disposed within said lateral channel and having two ends ; one end being in contact with said handle;
an engaging block disposed within the lateral channel and having a serrated portion which is engageable with said serrated section of said vertical tube and having a slanting face on the other surface thereof for making contact with the other end of said push rod; and
a quick-release mechanism for controlling said engaging block to either move upward or move downward.

2. An adjustable stem for a bicycle as claimed in claim 1, wherein said quick-release mechanism further comprises a compressed spring for pressing said engaging block.

3. An adjustable stem for a bicycle as claimed in claim 1, wherein said push rod is provided with a slanting face on one end thereof for making contact with said slanting face of said engaging block.
